(19) United States
(12) Patent Application Publication
(10) Pub. No.: US 2011/0117345 A1
(43) Pub. Date: May 19, 2011

(54) Optical Article

(75) Inventors: Keiji NISHIMOTO, Ina-shi (JP); Mitsuhiro TODA, Nagano-ken (JP); Naoki UCHIDA, Nagano-ken (JP)

(73) Assignee: SEIKO EPSON CORPORATION, Tokyo (JP)

(21) Appl. No.: 12/914,464

(22) Filed: Oct. 28, 2010

(30) Foreign Application Priority Data
Nov. 17, 2009 (JP) 2009-261585

(51) Int. Cl. B32B 7/02; B05D 5/06

(52) U.S. Cl. 428/216; 427/162

(57) ABSTRACT

An optical article includes: an optical base material; a primer layer formed on the optical base material; a binder layer; and a hardcoat layer formed on the primer layer via the binder layer, the primer layer having a thickness of at least 700 nm, the binder layer having a lower refractive index than the refractive index of the primer layer and the refractive index of the hardcoat layer, and the binder layer having a thickness of at least 35 nm.

### BACKGROUND

1. Technical Field

The present invention relates to optical articles used for lenses such as eyeglass lenses, and for other optical materials and products.

2. Related Art

JP-A-2009-67845 (Patent Document 1) describes primer compositions and methods of preparation thereof that enable the deposition of a primer layer which, despite a high refractive index, provides good adhesion to plastic lens base materials and hardcoatings, and can thus ensure improved lens impact resistance. In this connection, Patent Document 1 describes forming a primer layer on at least one surface of a plastic base material using a primer-forming composition that contains (A) polyurethane resin particles, (B) a urethane-forming monomer and/or oligomer, and (C) oxide microparticles, and forming a hardcoat layer on the primer layer.

The occurrence of fringe patterns' becomes likely as the refractive index difference between an optical base material (such as a plastic base material) and the primer layer, and/or between the primer layer and the hardcoat layer increases. In response to the recent advent of high-refractive-index plastic base materials having a refractive index higher than 1.7, efforts to suppress fringe patterns have been directed toward increasing the refractive indices of the primer layer and the hardcoat layer.

One way to increase the refractive indices of the primer layer and the hardcoat layer is to increase the proportion of the oxide microparticles. However, because increasing the oxide microparticle proportion leads to a relative decrease in the resin component, the adhesion between the primer layer and the hardcoat layer tends to decrease. This limits the composition of the primer layer; or combinations of the compositions of the primer layer and the hardcoat layer as in Patent Document 1. In other words, the foregoing approach narrows the range of selection in the layer (film) design of a lens. Accordingly, it has been difficult to find the compositions that can desirably satisfy, many different conditions, including impact resistance, adhesion, durability, and ease of manufacture. This has caused a delay in the introduction of a high-refractive-index lens in the market.

### SUMMARY

An aspect of the invention is directed to an optical article including: an optical base material a primer layer formed on the optical base material; a binder layer; and a hardcoat layer formed on the primer layer via the binder layer. In the optical article, the primer layer has a thickness of at least 700 nm, the binder layer has a lower refractive index than the refractive index of the primer layer and the refractive index of the hardcoat layer, and the binder layer has a thickness of at least 35 nm.

The inventors of the invention have found that the adhesion between the primer layer and the hardcoat layer can be improved when a binder layer of lower refractive index than those of the primer layer and the hardcoat layer is provided between the primer layer and the hardcoat layer, and when the thickness of the binder layer is at least 35 nm. Because the low-refractive-index layer has a relatively larger proportion of the resin component, the adhesion between the primer layer and the hardcoat layer can be improved, and the range of selection of the compositions used to deposit the primer layer and the hardcoat layer can be widened.

The inventors of the invention have also found that the provision of the binder layer between the primer layer and the hardcoat layer increases ripples in the reflection spectrum when an antireflective layer is formed on the hardcoat layer, and produces more fringe pattern. The present inventors have found that the fringe pattern can be suppressed by setting the thickness of the primer layer to at least 700 nm.

With the optical article according to the aspect of the invention, the adhesion between the primer layer and the hardcoat layer can be improved by the provision of the binder layer between these layers. The fringe pattern also can be suppressed. This widens the selection range of the compositions used to deposit the primer layer and the hardcoat layer in an optical article provided with an optical base material having a refractive index of about 1.7 or higher. Market introduction of an optical article having a high-refractive-index optical base material suited for a variety of applications is thus facilitated.

The fringe pattern in the optical article can be further suppressed when the thickness of the primer layer is preferably at least 800 nm, more preferably at least 900 nm. Further preferably, the thickness of the primer layer is at least 1,000 nm.

In the optical article, the binder layer has a thickness of preferably at least 50 nm. In this way, the adhesion between the primer layer and the hardcoat layer can be further improved.

In the optical article, the optical base material has a refractive index of preferably at least 1.7. The adhesion between the primer layer and the hardcoat layer can be improved, and the fringe pattern can be suppressed even with the optical base material of such a high refractive index, without relatively choosing compositions.

The optical article preferably includes an inorganic, multilayer antireflective layer formed on the hardcoat layer. The fringe pattern can be suppressed even with the inorganic, multilayer antireflective layer formed on the hardcoat layer.

The optical article is, for example, a lens. Thus, the optical base material may be a lens base material. The optical article has a wide range of applications, including various types of thin optical lenses, such as an eyeglass lens, a camera lens, a telescope lens, a microscope lens, and a condensing lens for steppers.

Another aspect of the invention is directed to eyeglasses including an eyeglass lens that uses the optical article. A high-refractive-index optical base material can be suitably used for the optical article. Specifically, because the eyeglass lens can use a high-refractive-index lens base material, a further reduction in the thickness of the eyeglasses can be attained.

Still another aspect of the invention is directed to an optical article manufacturing method including: applying and temporarily calcining a first composition used to form a primer layer on an optical base material; and forming a laminate on the optical base material by applying and calcining a second composition used to form a hardcoat layer. The laminate is formed under controlled temporary calcining temperature so as to laminate; the primer layer on the optical base material; a binder layer of lower refractive index than the refractive index of the primer layer; and the hardcoat layer.

With the manufacturing method according to the aspect of the invention, an optical article can be manufactured that has good adhesion owning to the binder layer interposed between the primer layer and the hardcoat layer, and that produces less fringe pattern.

Yet another aspect of the invention is directed to an optical article designing method for designing an optical article provided with a binder layer-containing laminate that includes: a primer layer on an optical base material; a binder layer of lower refractive index than the refractive index of the primer layer; and a hardcoat layer. The method includes setting the thickness of the primer layer in the binder layer-containing laminate to a second thickness that is at least twice as thick as a first thickness of a primer layer of a binder layer-less laminate that includes the primer layer and a hardcoat layer laminated on an optical base material.

With the designing method according to the aspect of the invention, an optical article can be manufactured that has good adhesion owning to the binder layer interposed between the primer layer and the hardcoat layer, and that produces less fringe pattern.

### BRIEF DESCRIPTION OF THE DRAWINGS

The invention will be described with reference to the accompanying drawings, wherein like numbers reference like elements.

FIG. 1 is a diagram schematically illustrating a layer structure of a first optical article.

FIG. 2 is a diagram schematically illustrating a layer structure of a second optical article.

FIG. 3 is a diagram explaining a layer structure of an antireflective layer provided for the optical articles of Comparative Examples 1 and 2.

FIG. 4A is a diagram illustrating a fringe pattern of the optical article of Comparative Example 1; FIG. 4B is a diagram illustrating a fringe pattern of the optical article of Comparative Example 2.

FIG. 5 is a diagram representing the result of a simulation of the reflection spectra of the optical articles of Comparative Examples 1 and 2.

FIG. 6 is a diagram representing the result of a simulation between primer layer thickness and hue angle in the optical articles of Comparative Examples 1 and 2.

FIG. 7 is a diagram summarizing the relationship between temporary calcining temperature and binder layer thickness along with the evaluation results of adhesion and fringe pattern.

FIG. 8 is a diagram representing the result of a simulation between primer layer thickness and hue angle in an optical article of Example 1.

FIG. 9 is a diagram explaining a layer structure of an antireflective layer provided for an optical article of Example 2.

FIG. 10 is a diagram explaining a layer structure of an antireflective layer provided for an optical article of Example 3.

FIG. 11 is a diagram representing the result of a simulation between primer layer thickness and hue angle in the optical articles of Examples 1 to 3.

FIG. 12 is a diagram representing the relationship between binder layer thickness and the minimum thickness of the primer layer in the optical articles of Examples 1 to 3.

FIG. 13 is a diagram representing the relationship between binder layer thickness and the minimum thickness of the primer layer in the optical articles fabricated to obtain a hue angle displacement within the ±1.5°, ±2.0°, and ±2.5° ranges.

### DESCRIPTION OF EXEMPLARY EMBODIMENTS

The following specifically describes an eyeglass lens as an example of an optical article according to the invention.

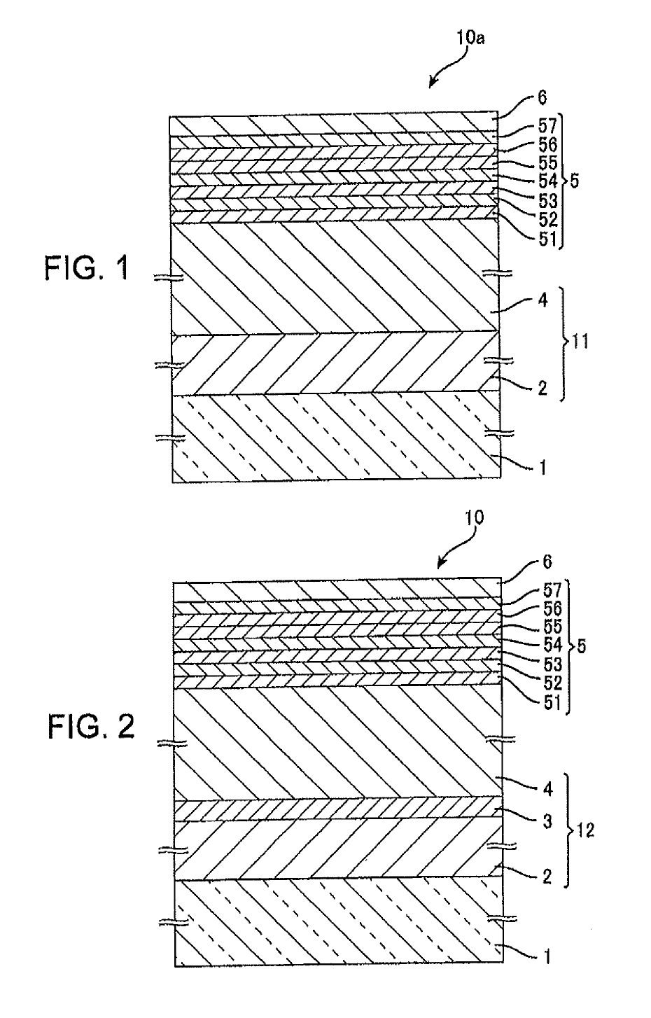

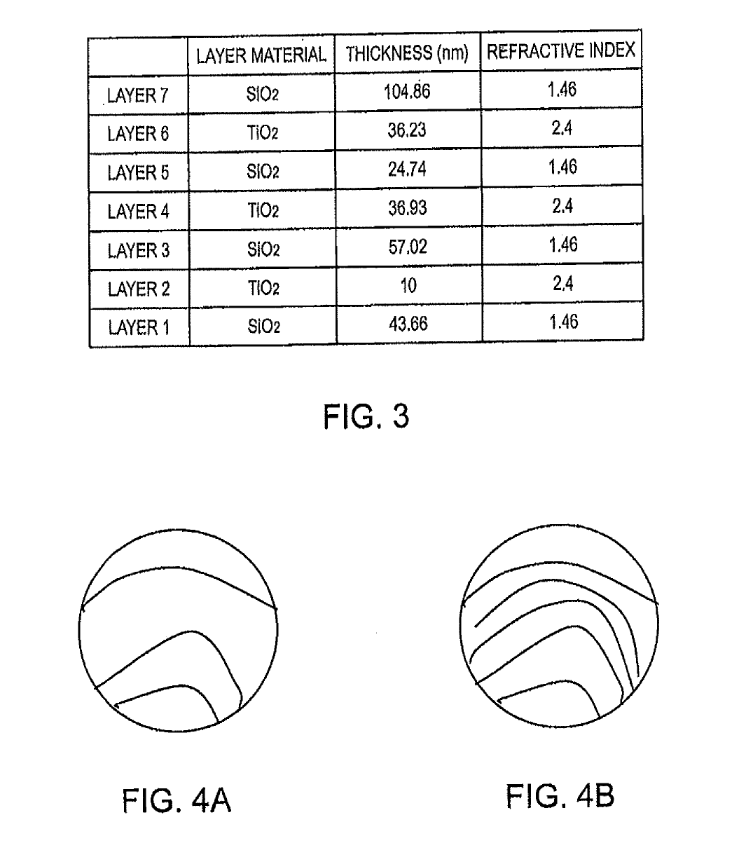

FIG. 1 schematically illustrates a layer structure of an eyeglass lens 10a that includes a binder layer-less laminate 11. FIG. 2 schematically illustrates a layer structure of an eyeglass lens 10 that includes a binder layer-containing laminate 12. FIG. 3 presents the layer structure of the antireflective layer of the eyeglass lenses 10a and 10.

### 1. Comparative Examples 1 and 2

The eyeglass lens 10a including the binder layer-less laminate 11 as illustrated in FIG. 1 includes a lens base material (optical base material) 1, a primer layer 2 formed on the lens base material 1, and a hardcoat layer 4 formed on the primer layer 2. The primer layer 2 and the hardcoat layer 4 directly formed on the primer layer 2 form the binder layer-less laminate 11. The eyeglass lens 10a further includes a translucent antireflective layer 5 formed on the hardcoat layer 4, and an antifouling layer 6 formed on the antireflective layer 5. The optical base material 1 may be, for example, a plastic base material (for example, plastic lens base material). The antifouling layer 6 may be omitted.

The eyeglass lens 10 including the binder layer-containing laminate 12 as illustrated in FIG. 2 includes a lens base material (optical base material) 1, a primer layer 2 formed on the lens base material 1, and a hardcoat layer 4 formed on the primer layer 2 via a binder layer 3. The primer layer 2, the binder layer 3, and the hardcoat layer 4 formed on the binder layer 3 form the binder layer-containing laminate 12. The eyeglass lens 10 further includes a translucent antireflective layer 5 formed on the hardcoat layer 4, and an antifouling layer 6 formed on the antireflective layer 5. As in the eyeglass lens 10, the optical base material 1 may be, for example, a plastic base material (for example, plastic lens base material). The antifouling layer 6 may be omitted.

1a. Lens Base Material

The lens base material 1 is not particularly limited. Examples of the usable materials include: (meth)acrylic resin; styrene resin; polycarbonate resin; allyl resin; allyl carbonate resin such as diethylene glycol bis(allyl carbonate) resin (for example, CR-39® available from PPG Industries Ohio Inc.); vinyl resin; polyester resin; polyether resin; urethane resin obtained by the reaction of an isocyanate compound with a hydroxy compound such as diethylene glycol; thiourethane resin obtained by the reaction of an isocyanate compound with polythiol compound; and transparent resins obtained by curing, for example, a polymerizable composition that includes a (thio)epoxy compound having one or more disulfide bonds within the molecule. The lens base material 1 has a refractive index of, for example, about 1.60 to about 1.75. In the optical article of an embodiment of the invention, the refractive index of the optical base material may fall within this range, or outside this range.

1b. Primer Layer

The primer layer 2 effectively improves impact resistance, a quality lacking in high-refractive-index lens base materials. Examples of the materials usable for the primer layer 2 include acrylic resin, melamine resin, urethane resin, epoxy resin, polyvinyl acetal resin, amino resin, polyester resin, polyamide resin, vinyl alcohol resin, styrene resin, silicon resin, and a mixture or a copolymer of these. Urethane resin and polyester resin are preferably used to provide adhesion for the primer layer 2. The primer layer 2 can be formed, for example, by applying and curing a coating composition that includes such a resin, metal oxide microparticles, and a silane compound.

Specific examples of the metal oxide microparticles contained in the primer layer-forming coating composition include microparticles of metal oxides such as SiO₂, Al₂O₃, SnO₂, Sb₂O₅, Ta₂O₅, CeO₂, La₂O₃, Fe₂O₃, ZnO, WO₃, ZrO₂, In₂O₃, and TiO₂ and composite microparticles of metal oxides of two or more kinds of metal. The microparticles may be contained in the coating composition as a colloidal dispersion in a dispersion medium such as water, and alcohol or other organic solvents.

The primer layer 2 tends to improve impact resistance but suffer from poor adhesion when increased in thickness. In terms of impact resistance, the lower thickness limit of the primer layer 2 is 300 nm, preferably 400 nm. The upper thickness limit of the primer layer 2 is 2,000 nm, preferably about 1,500 nm, in terms of adhesion, and ease of deposition.

1c. Hardcoat Layer

The hardcoat layer 4 is provided to primarily improve abrasion resistance. Examples of the materials usable for the hardcoat layer 4 include acrylic resin, melamine resin, urethane resin, epoxy resin, polyvinyl acetal resin, amino resin, polyester resin, polyamide resin, vinyl alcohol resin, styrene resin, silicone resin, and a mixture or a copolymer of these. The hardcoat layer is, for example, a silicone resin. The hardcoat layer 4 can be formed, for example, by applying and curing a coating composition that includes such a resin, metal oxide microparticles, and a silane compound. The coating composition may include (a mixture of) components such as colloidal silica and a polyfunctional epoxy compound.

Specific examples of the metal oxide microparticles contained in the hardcoat layer-forming coating composition include microparticles of metal oxides such as SiO₂, Al₂O₃, SnO₂, Sb₂O₅, Ta₂O₅, CeO₂, La₂O₃, Fe₂O₃, ZnO, WO₃, ZrO₂, In₂O₃, and TiO₂, and composite microparticles of metal oxides of two or more kinds of metal. The microparticles may be contained in the coating composition as a colloidal dispersion in a dispersion medium such as water, and alcohol and other organic solvents.

1d. Binder Layer

The binder layer 3 may be formed by coating the primer layer 2 with a composition that can improve the adhesion between the primer layer 2 and the hardcoat layer 4 such as a composition that has a higher proportion of the resin component than the primer layer 2 and the hardcoat layer 4, or may be formed on the primer layer 2 by adjusting the calcining (temporary calcining) temperature of the primer layer-forming coating composition after application.

The binder layer 3 is typically formed using a component that is primarily the resin component of the primer layer-forming coating composition. Thus, the binder layer 3 with a higher resin concentration can be formed on the primer layer 2 by the deposition of the resin component of the primer layer-forming coating composition on the primer layer surface during the temporary calcining. The binder layer 3 formed in this manner has a high resin concentration, and thus has a lower refractive index than the primer layer 2 and the hardcoat layer 4. Because of the high resin concentration (a relatively large amount of resin component), the binder layer 3 can improve the adhesion between the primer layer 2 and the hardcoat layer 4.

Aside from forming the binder layer 3, adjustment of the temporary calcining temperature can also adjust the thickness of the binder layer 3. Generally, the thickness of the binder layer 3 tends to increase as the temporary calcining temperature increases, regardless of the resin component or other components contained in the primer layer-forming coating composition.

1e. Antireflective Layer

The antireflective layer 5 formed on the hardcoat layer 4 is typically an inorganic antireflective layer, but may be an organic antireflective layer. The inorganic antireflective layer typically has a multilayer structure, and can be formed, for example, by alternately laminating a low-refractive-index layer having a refractive index of 1.3 to 1.6, and a high-refractive-index layer having a refractive index of 1.8 to 2.6. The antireflective layer may include, for example, about 5 or 7 such layers. Examples of the inorganic material usable for the constituent layers of the antireflective layer include SiO₂, SiO, ZrO₂, TiO₂, TiO, Ti₂O₃, Ti₂O₅, Al₂O₃, TaO₂, Ta₂O₅, NdO₂, NbO, Nb₂O₃, NbO₂, Nb₂O₅, CeO₂, MgO, SnO₂, MgF₂, WO₃, HfO₂, and Y₂O₃. These inorganic materials may be used either alone or as a mixture of two or more. The antireflective layer 5 can be formed by using a dry method such as a vacuum vapor deposition method, an ion plating method, and a sputtering method.

One of the methods that can be used to form an organic antireflective layer is the wet method. The organic antireflective layer can be formed (deposited) in the same manner as for the primer layer and the hardcoat layer, for example, by applying a coating composition (antireflective layer-forming coating composition) that contains silica microparticles having inner cavities (hollow silica-microparticles), and an organosilicon compound. The reason the hollow silica-microparticles are contained in the antireflective layer-forming coating composition is to trap a gas or a solvent of a lower refractive index than silica inside the inner cavities. This further lowers the refractive index than in the silica microparticles having no cavities, and a superior antireflection effect can be obtained. The hollow silica-microparticles can be made, for example, according to the method described in JP-A-2001-233611. Typically, hollow silica-microparticles having an average particle size of from 1 to 150 nm, and a refractive index of from 1.16 to 1.39 may be used. The preferable thickness of the organic antireflective layer is 50 to 150 nm.

1f. Antifouling Layer

A water-repellent film, or a hydrophilic anti-fog film (collectively referred to as “antifouling layer”) 6 is often formed on the antireflective layer 5. The antifouling layer 6 is, for example, a layer of a fluorine-containing organosilicon compound formed on the antireflective layer 5 for the purpose of improving the water-repellent and oil-repellent performance on the surface. The fluorine-containing silane compounds described in, for example, JP-A-2005-301208 and JP-A-2006-126782 can preferably be used as the fluorine-containing organosilicon compound.

The fluorine-containing silane compound is preferably dissolved in an organic solvent, and used as a water-repellent treatment liquid (antifouling layer-forming coating composition) adjusted to a predetermined concentration. The antifouling layer 6 can be formed (deposited), for example, by applying the water-repellent treatment liquid on the antireflective layer 5. A dipping method and a spin coating method can be used for this purpose. The antifouling layer 6 also may be formed using a dry method such as a vacuum vapor deposition method, after charging the water-repellent treatment liquid into metal pellets.

The thickness of the antifouling layer 6 that contains the fluorine-containing silane compound is not particularly limited, and is preferably 0.001 to 0.5 μm, more preferably 0.001 to 0.03 μm. When the thickness of the antifouling layer 6 is too thin, the water-repellent and oil-repellent effect becomes weak. When too thick, the surface becomes sticky. A thickness of the antifouling layer 6 above 0.03 μm may lower the antireflection effect.

### 1.1 Fabrication of Lens Sample

As Comparative Examples 1 and 2, a binder layer-less eyeglass lens 10a (Comparative Example 1), and a binder layer-containing eyeglass lens 10 (Comparative Example 2) were prepared that included a lens base material 1 having a refractive index of 1.748, a primer layer 2 having a refractive index of 1.635 and a thickness of 400 nm, and a hardcoat layer 4 having a refractive index of 1.642 and a thickness of 1,513 nm. The binder layer-containing eyeglass lens 10 (eyeglass lens of Comparative Example 2) also included a binder layer 3 having a refractive index of 1.597 and a thickness of 100 nm.

An inorganic, multilayer antireflective layer 5 was also formed in the eyeglass lens 10a of Comparative Example and the eyeglass lens 10 of Comparative Example 2. Specifically, as illustrated in FIG. 3, the antireflective layer 5 is of a 7 layer type including alternately laminated low-refractive-index layers and high-refractive-index layers. The low-refractive-index layers are SiO₂ layers (refractive index 1.46) including a first layer 51, a third layer 53, a fifth layer 55, and a seventh layer 57. The high-refractive-index layers are TiO₂ layers (refractive index 2.4) including a second layer 52, a fourth layer 54, and a sixth layer 56. The first layer 51, the second layer 52, the third layer 53, the fourth layer 54, the fifth layer 55, the sixth layer 56, and the seventh layer 57 have thicknesses of 43.66 nm, 10 nm, 57.02 nm, 36.93 nm, 24.74 nm, 36.23 nm, and 104.86 nm, respectively.

### 1.1.1 Preparation of Primer Layer-Forming First Composition (Polyester Primer)

A stainless-steel container was charged with 2,900 parts by mass of methyl alcohol, and 50 parts by mass of a 0.1 normal sodium hydroxide aqueous solution. After thorough stirring, 750 parts by mass of a composite microparticle sol (rutile-type crystal structure; methanol dispersion; surface treatment agent, γ-glycidoxypropyltrimethoxysilane; the total solid content, 20 mass %; product name: Optolake, Shokubai Kasei Kogyo) of primarily titanium oxide, tin oxide, and silicon oxide was added, and mixed by stirring. Then, 1,000 parts by mass of polyurethane resin (water dispersion; the total solid content, 35 mass %; product name: Superflex 210, Dai-Ichi Kogyo Seiyaku Co., Ltd.) was added, and mixed by stirring. After adding 2 parts by mass of a silicone-based surfactant (product name: L-7604, Dow Corning Toray Co., Ltd.), the mixture was stirred overnight. This was followed by filtration through a 2-μm filter to give the first composition (primer layer-forming composition).

### 1.1.2 Preparation of Hardcoat Layer-Forming Second Composition

A stainless-steel container was charged with 1,000 parts by mass of propylene glycol monomethyl ether, and 1,200 parts by mass of γ-glycidoxypropyltrimethoxysilane was added. After thorough stirring, 300 parts by mass of a 0.1 mol/liter hydrochloric acid aqueous solution was added. The mixture was stirred overnight to give a silane hydrolysate. Then, 30 parts by mass of a silicone-based surfactant (product name: L-7001, Dow Corning Toray Co., Ltd.) was added to the silane hydrolysate. After 1-hour stirring, 7,300 parts by mass of a composite microparticle sol (rutile-type crystal structure; methanol dispersion; surface treatment agent, γ-glycidoxypropyltrimethoxysilane; product name: Optolake, Shokubai Kasei Kogyo) of primarily titanium oxide, tin oxide, and silicon oxide was added, and mixed by stirring for 2 hours. The mixture was further stirred for 2 hours after adding 250 parts by mass of an epoxy resin (product name: EX-313, Nagase Kasei), and 20 parts by mass of iron(III) acetylacetonate was added. After 1-hour stirring, the mixture was filtered through a 2-μm filter to give the second composition (hardcoat layer-forming composition).

### 1.1.3 Formation of Binder Layer-less Laminate 11

A plastic lens base material (refractive index n=1.748; product name: Seiko Prestige, Seiko Epson) was prepared as the lens base material 1. The lens base material 1 was subjected to an alkali treatment. The lens base material 1 was immersed in a 50° C. 2 mol/liter potassium hydroxide aqueous solution for 5 minutes, washed with deionized water, and immersed in 25° C. 1.0 mol/liter sulfuric acid for 1 minute for neutralization. The lens base material 1 was washed with deionized water, dried, and allowed to cool.

The lens base material 1 was then immersed in the first composition prepared in 1.1.1. After dip coating at a specified pull-up speed, the lens base material 1 was calcined at 50° C. for 20 minutes to form the primer layer 2 on the surface of the lens base material 1. In the following, this temperature will be referred to as temporary calcining temperature th.

The lens base material 1 with the primer layer 2 was then immersed in the second composition prepared in 1.1.2. After dip coating at a specified pull-up speed, the whole was dried and calcined at 80° C. for 30 minutes to form the hardcoat layer 4 on the primer layer 2.

This was followed by heating in a 125° C. oven for 3 hours. After these steps, a lens sample of Comparative Example 1 was obtained that included the binder layer-less laminate 11 including the primer layer 2 of refractive index 1.635, and the hardcoat layer 4 of refractive index 1.642.

### 1.1.4 Formation of Binder Layer-Containing Laminate 12

A lens sample of Comparative Example 2 including the binder layer-containing laminate 12 was formed according to the procedure of 1.1.3. The temporary calcining temperature th after the application of the primer layer-forming first composition was changed to 100° C. As a result, a lens sample of Comparative Example 2 was obtained that included the binder layer-containing laminate 12 including the binder layer 3 having a refractive index of 1.597 and a thickness of 100 nm between the primer layer 2 of refractive index 1.635, and the hardcoat layer 4 of refractive index 1.642.

The binder layer 3 also can be formed, for example, by applying a composition having a higher proportion of the resin component than the primer layer 2 and the hardcoat layer 4 on the primer layer 2. The thickness of the binder layer 3 can be desirably varied by varying the temporary calcining temperature th, as will be described later.

### 1.1.5 Formation of Antireflective Layer and Antifouling Layer

Using a vacuum vapor deposition method, the antireflective layer 5 was formed on the lens sample of Comparative Example 1 including the binder layer-less laminate 11, and on the lens sample of Comparative Example 2 including the binder layer-containing laminate 12. Specifically, the antireflective layer 5 of a seven-layer structure including a SiO₂ layer 51, a TiO₂ layer 52, a SiO₂ layer 53, a TiO₂ layer 54, a SiO₂ layer 55, a TiO₂ layer 56, and a SiO₂ layer 57 disposed in this order from the hardcoat layer 4 side toward the atmosphere was formed (deposited) using a vacuum vapor deposition apparatus.

After forming the antireflective layer 5, the antifouling layer 6 was formed. The surface of the seventh layer 57 in the antireflective layer 5 was subjected to an oxygen plasma treatment, and the antifouling layer 6 was formed (deposited) using the deposition source pellet material that contained a water-repellent treatment liquid (product name: KY-130, Shin-Etsu Chemical Co., Ltd.) containing a fluorine-containing organosilicon compound of a large molecular weight, using a vacuum vapor deposition apparatus.

After the vapor deposition, the lens base material with the antireflective layer 5 and the antifouling layer 6 formed on one side was taken out of the vacuum vapor deposition apparatus, flipped, and placed in the apparatus again. The foregoing procedure (formation of the antireflective layer 5 and the antifouling layer 6) was then repeated. As a result, the antireflective layer 5 and the antifouling layer 6 were also formed on the other side, and the eyeglass lens of interest was obtained. The antifouling layer 6 also can be deposited by applying a water-repellent treatment liquid on the antireflective layer 5. Methods such as a dipping method and a spin coating method can be used for this purpose.

### 1.2 Fringe Pattern

FIG. 4A illustrates a fringe pattern of the lens sample of Comparative Example 1. FIG. 4B illustrates a fringe pattern of the lens sample of Comparative Example 2. In contrast to the lens sample of Comparative Example 1 provided with the binder layer-less laminate 11, the lens sample of Comparative Example 2 provided with the binder layer-containing laminate 12 has more fringes. It is therefore needed to suppress the fringe pattern in the lens sample of Comparative Example 2 having the binder layer containing laminate 12.

### 1.3 Simulation

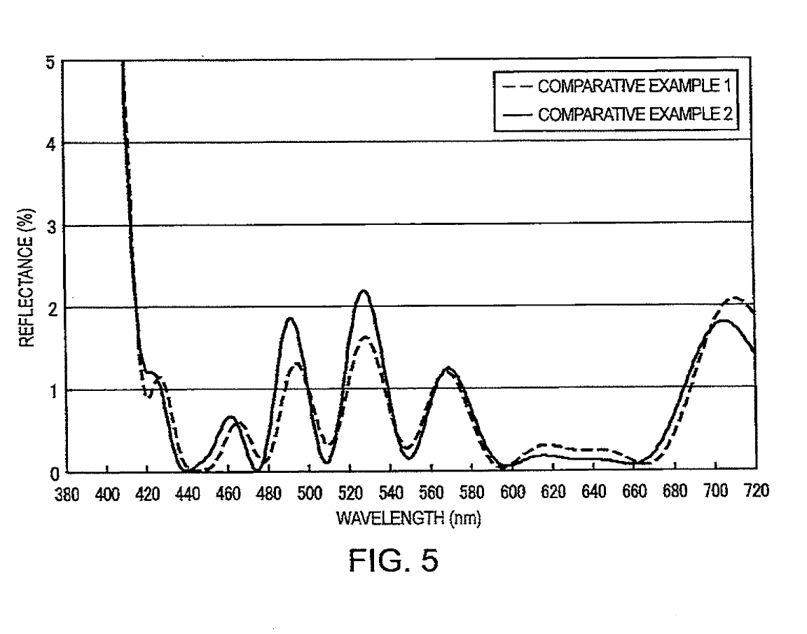

FIG. 5 represents reflection spectra from the lens sample of Comparative Example 1 provided with the binder layer-less laminate 11, and the lens sample of Comparative Example 2 provided with the binder layer-containing laminate 12. A white light source with flat characteristics was used as the light source. In both samples, reflectance is sufficiently low in the visible light region, and the lens has good translucency. However, unlike the sample of Comparative Example 1, the reflection spectrum of the sample of Comparative Example 2 had the tendency to show more little ripples in the reflectance in the visible light region.

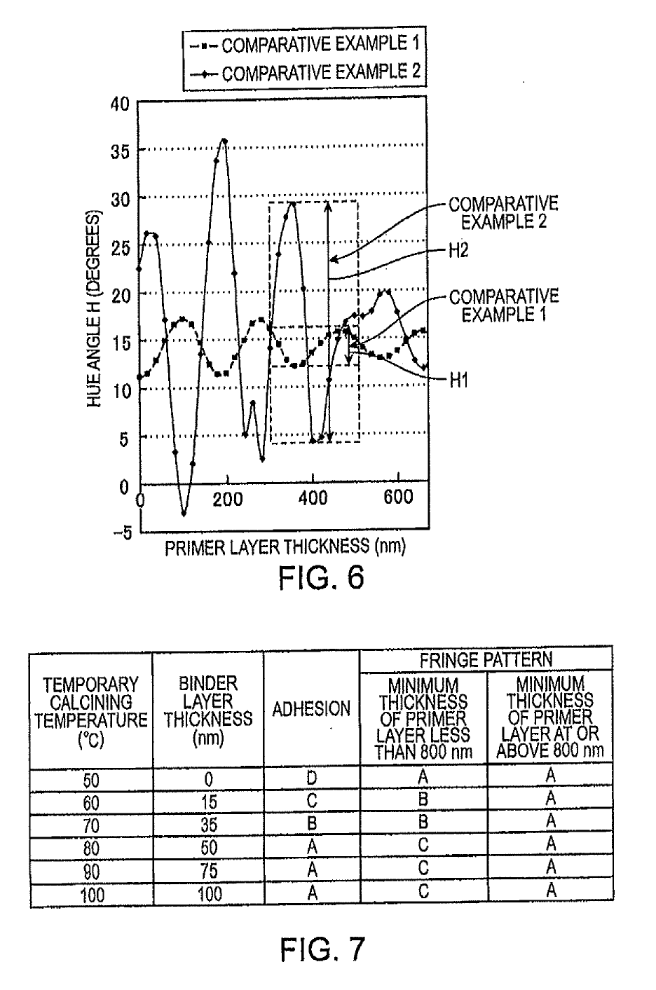

FIG. 6 is the result of a simulation between primer layer thickness and hue angle for the lens sample of Comparative Example 1 provided with the binder layer-less laminate 11, and the lens sample of Comparative Example 2 provided with the binder layer-containing laminate 12. Hue angle H is the value determined from the a* and b* values of the L*a*b* color system (CIE 1976, CIELab color space)—a color space specified by the CIE (The International Commission on Illumination) in 1976—and has the following relationship.

tan(H)=b*/a* (1)

Hue angle H was determined by using the program TFCalc available from Hulinks Inc. A flat light source (white light source) that has no intensity distribution was assumed for the light source, and a detector with a flat sensory curve was assumed for an eye. The incident angle on the normal line was taken as 0. The optical constant, thickness, and other parameters of each sample used in the simulation are as noted above.

As shown in FIG. 6, changes in hue angle H for different thickness of the primer layer are larger in the lens sample of Comparative Example 2 provided with the binder layer-containing laminate 12 than in the lens sample of Comparative Example 1 provided with the binder layer-less laminate 11. It can be seen from this result that the lens sample of Comparative Example 2 is likely to produce a fringe pattern that results from large hue fluctuations due to the thickness tolerance at different parts of the primer layer. For example, in contrast to the amount of change (displacement) H1 of about 5° for the hue angle H at 400 nm±100 nm in Comparative Example 1, the amount of change (displacement) H2 of hue angle H at 400 nm±100 nm was about 25° in Comparative Example 2, a value about five times greater than that of Comparative Example 1. Thus, when the fringe pattern in the optical article (eyeglass lens) provided with the binder layer-containing laminate 12 is to be suppressed at about the same level as that in the optical article provided with the binder layer-less laminate 11, the amount of change H2 of hue angle H needs to be brought down to a value about the same as H1, specifically, to 5° (±2.5°).

### 2. Example 1

As Example 1, lens samples with the binder layer-containing laminate 12 as in Comparative Example 2 were produced under different conditions. The thickness of the primer layer 2 in the eyeglass lens samples was varied with the pitch of 50 nm over the range of from 200 nm to 1,200 nm. The binder layer 3 in each sample had the thickness of 0 nm, 15 nm, 35 nm, 50 nm, 75 nm, or 100 nm, produced by varying the temporary calcining temperature th. All the other conditions are the same as those presented in Comparative Example 2.

### 2.1 Evaluation

FIG. 7 summarizes the results of the evaluation of the temporary calcining temperature, the thickness of the binder layer 3, the adhesion, and the fringe pattern of each lens sample produced in Example 1. The fringe pattern had a relatively clear boundary at the minimum thickness 800 nm of the primer layer 2, whereas adhesion had almost no dependence on the thickness of the primer layer 2.

There was a relationship between temporary calcining temperature th and the thickness of the binder layer 3. According to experiments conducted by the inventors of the invention, the binder layer 3 was not formed at temporary calcining temperatures at or below 50° C., whereas thickness of the binder layer 3 increased with increase in temporary calcining temperature th from 50° C., specifically, 15 nm, 35 nm, 50 nm, 75 nm, and 100 nm at 60° C., 70° C., 80° C., 90° C., and 100° C., respectively.

### Adhesion Evaluation Method

Adhesion was evaluated using the cross-cut tape test according to the grid method/grid tape method specified in JIS K 5400, 8.5.1 to 2. Specifically, a cut was made into the surface of the eyeglass lens 10 at 1-mm intervals with a cutter knife so as to form one hundred 1-mm2 squares. Then, a cellophane adhesive tape (product name: Cellotape®, Nichiban) was pressed against the lens surface hard, and quickly peeled off from the surface of the eyeglass lens 10 by pulling the tape in a 90° direction. The number of remaining coating squares after peeling the cellophane adhesive tape was categorized as follows.

A: No coating peeling (number of remaining squares: 100)

B: Almost no peeling (number of remaining squares: 99 to 95)

C: Modest peeling (number of remaining squares: 94 to 80)

D: Peeling (number of remaining squares: 79 to 30)

E: Almost full peeling (number of remaining squares: 29 to 0)

Peeling occurred when the binder layer 3 was thin, even under the condition where the thickness of the primer layer 2 was relatively thin and the peeling of the primer layer 2 from the lens base material 1 was therefore unlikely. Thus, it can be said that the results presented in FIG. 7 indicate the presence or absence of peeling (adhesion) between the primer layer 2 and the hardcoat layer 4.

### Fringe Pattern Evaluation Method

Fringe pattern was evaluated by observing the fringe pattern of the eyeglass lens in a dark box. Evaluation was made according to following criteria.

A: No fringe pattern under a three-wavelength fluorescent lamp; excellent appearance

B: Fringe pattern is observed under a three-wavelength fluorescent lamp, but not observed under a non-three-wavelength fluorescent lamp

C: Fringe pattern is observed under a three-wavelength fluorescent lamp and a non-three-wavelength fluorescent lamp; poor appearance

### Evaluation Results of Adhesion and Fringe Pattern

As shown in FIG. 7, the samples with the binder layer 3 thicknesses of 50 nm, 75 nm, and 100 nm scored A in the evaluation result of adhesion. The evaluation result of fringe pattern was also A when the thickness of the primer layer 2 was 800 nm or more. The results therefore show that a lens having good adhesion and desirable optical characteristics can be obtained when the thickness of the binder layer 3 is 50 nm or more, and when the minimum thickness of the primer layer 2 is 800 nm or more.

The sample with the binder layer 3 thickness of 35 nm scored B in the evaluation result of adhesion. Despite the slightly lower adhesion, the lens still had desirable adhesion for an eyeglass lens. The sample with the binder layer 3 thickness of 35 nm scored B for the evaluation result of fringe pattern even when the thickness of the primer layer 2 was 800 nm or less, provided that the minimum thickness of the primer layer 2 is at least about 700 nm. This result shows that a lens with good adhesion and desirable optical characteristics can be obtained even, when the thickness of the primer layer 2 is relatively thin.

Thus, in optical articles such as the eyeglass lens provided with the binder layer-containing laminate 12, it is preferable that the binder layer 3 have a thickness of at least 35 nm, preferably 50 nm, and that the primer layer 2 have a thickness of at least 700 nm. In this way, the fringe pattern can be suppressed even with the lens base material 1, the primer layer 2, and the hardcoat layer 4 of high refractive index.

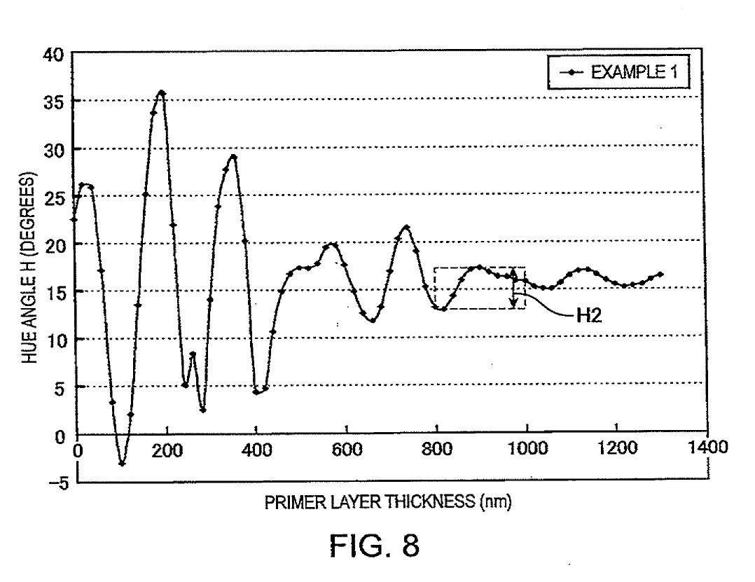

FIG. 8 is the result of a simulation between primer layer 2 thickness and hue angle H performed under the conditions of FIG. 6 for the eyeglass lens sample of Example 1, for which the thickness of the binder layer 3 was set to 100 nm as in the sample of Comparative Example 2. It can be seen from this simulation result that the hue angle tends to decrease with increase in thickness of the primer layer 2 in the lens sample 10 provided with the binder layer-containing laminate 12. It can also be seen that the displacement (amount of change) H2 of the hue angle H falls within a range of about ±2.5° when the minimum thickness of the primer layer 2 with an expected tolerance of ±100 nm is 800 nm, specifically, at the primer layer 2 thickness of 900 nm±100 nm, as does the displacement H1 of the hue angle of the lens sample 10a (Comparative Example 1) provided with the binder layer-less laminate 11.

The simulation result coincides with the evaluation results of each sample of Example 1 presented in FIG. 7. Considering that the thickness of the primer layer 2 used for the evaluation of the hue angle displacement H1 in the simulation for the Comparative Example 1 is 400 nm±100 nm (the minimum thickness of 300 nm), it is desirable that the thickness of the primer layer 2 of the binder layer-containing laminate 12 exceed that of the binder layer-less laminate 11 by a factor of at least 2, preferably about 2.5, further preferably about 3 or more.

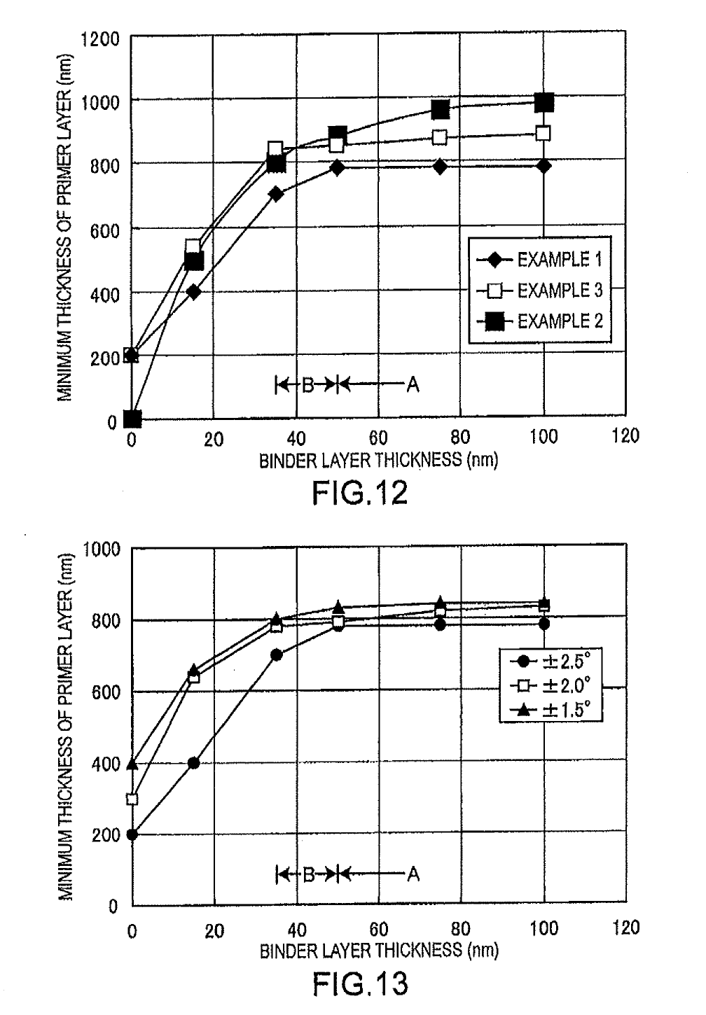

The minimum thickness Tm(2.5) of the primer layer 2 that produces a hue angle displacement H2 higher than ±2.5° was also found by simulation for each sample of Example 1. The results are shown in FIG. 12, along with the results for Examples 2 and 3 described below.

### 3. Examples 2 and 3

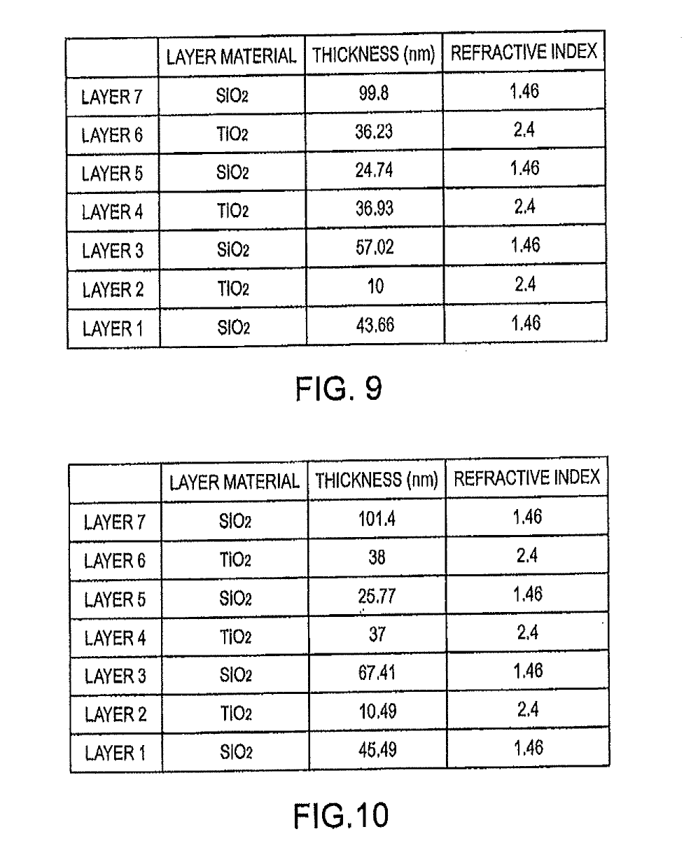

Simulation was performed as above for the lens samples of Examples 2 and 3 that included binder layer-containing laminates 12 having the layers of different compositions and different refractive indices. The sample of Example 2 used a lens base material 1 of refractive index 1.676, and a binder layer-containing laminate 12 that included a primer layer 2 of refractive index 1.597, a binder layer 3 of refractive index 1.501, and a hardcoat layer 4 of refractive index 1.597. The layer structure of the antireflective layer 5 is as shown in FIG. 9.

The sample of Example 3 used a lens base material 1 of refractive index 1.786, and a binder layer-containing laminate 12 that included a primer layer 2 of refractive index 1.7331, a binder layer 3 of refractive index 1.642, and a hardcoat layer 4 of refractive index 1.741. The layer structure of the antireflective layer 5 is as shown in FIG. 10.

### 3.1 Examples of Primers

### 3.1a Example of Polyurethane Primer of Refractive Index 1.7331

The primer layer 2 of refractive index 1.7331 of Example 3 can be deposited as follows. First, a stainless-steel container is charged with 2,900 parts by mass of methyl alcohol, and 50 parts by mass of a 0.1 normal sodium hydroxide aqueous solution. After thorough stirring, 1,500 parts by mass of a composite microparticle sol (rutile-type crystal structure; methanol dispersion; surface treatment agent, γ-glycidoxypropyltrimethoxysilane; the total solid content, 20 mass %; product name: Optolake, Shokubai Kasei Kogyo) of primarily titanium oxide, tin oxide, and silicon oxide is added, and mixed by stirring. Then, 580 parts by mass of a polyurethane resin (water dispersion; the total solid content, 35 mass %; product name: Superflex 210, Dai-Ichi Kogyo Seiyaku Co., Ltd.), and 35 parts by mass of γ-glycidoxypropyltrimethoxysilane are added, and mixed by stirring. Thereafter, 2 parts by mass of a silicone-based surfactant (product name: L-7604, Dow Corning Toray Co., Ltd.) is added, and stirred overnight. The mixture is then filtered through a 2-μm filter to give a primer layer-forming composition.

### 3.1b Example of Polyester Primer of Refractive Index 1.7331

The primer layer 2 of refractive index 1.7331 of Example 3 may be deposited as follows. A stainless-steel container is charged with 210 parts by mass of methyl alcohol, and 100 parts by mass of water. After thorough stirring and mixing, 120 parts by mass of a composite microparticle sol (rutile-type crystal structure; methanol dispersion; the total solid content, 20 weight; product name: Optolake 1120Z, Shokubai Kasei Kogyo) of primarily titanium oxide, tin oxide, and silicon oxide is added, and mixed by stirring. After stirring and mixing, 40 parts by mass of aqueous polyester (Itoh Optical Industrial Co., Ltd.) is added, and mixed by stirring. Then, 1 part by mass of a silicone-based surfactant (product name: L-7604, Nippon Unicar Company Limited) is added, and the mixture is stirred for 2 hours to give a primer layer-forming composition.

### 3.1c Example of Polyvinyl Alcohol Primer of Refractive Index 1.7331

The primer layer 2 of refractive index 1.7331 of Example 3 may be deposited as follows. A stainless-steel container is charged with 70 parts by mass of methanol, and 600 parts by mass of water. The solution is then mixed with 100 parts by mass of completely saponificated polyvinyl alcohol (Wako Pure Chemical Industries, Ltd.) having an average degree of polymerization of 1,000 mixed with 900 parts by mass of deionized water. Then, 100 parts by mass of a completely dissolved polyvinyl alcohol solution retained at 90° C. for 3 hours is mixed and dissolved in the mixture. Then, 200 parts by mass of a composite microparticle sol (rutile-type crystal structure; methanol dispersion; surface treatment agent, γ-glycidoxypropyltrimethoxysilane; product name: Optolake, Shokubai Kasei Kogyo; solid content, 20%) of primarily titanium oxide, tin oxide, and silicon oxide is added and stirred, and 2 parts by mass of urea is added and completely dissolved in the mixture. Thereafter, 7 parts by mass of a 0.1 N hydrochloric acid aqueous solution, and 1 part by mass of a silicone-based surfactant (product name: L-7604, Dow Corning Toray Co., Ltd.) are added, and the mixture is stirred for 30 minutes to give a primer layer-forming composition.

### 3.1d Example of Polyester Primer of Refractive Index 1.635

The primer layer 2 of refractive index 1.635 of Example 1 may be deposited as follows. A stainless-steel container is charged with 220 parts by mass of methyl alcohol, and 100 parts by mass of water. After thorough stirring and mixing, 70 parts by mass of a composite microparticle sol (rutile-type crystal structure; methanol dispersion; total solid content, 20 weight %; product name: Optolake1120Z, Shokubai Kasei Kogyo) of primarily titanium oxide, tin oxide, and silicon oxide is added, and mixed by stirring. After stirring and mixing, 80 parts by mass of aqueous polyester (Itoh Optical Industrial Co., Ltd.) is added, and mixed by stirring. Then, 1 part by mass of a silicone-based surfactant (product name: L-7604, Nippon Unicar Company Limited) is added, and the mixture is stirred for 2 hours to give a primer layer-forming composition.

### 3.1e Example of Vinyl Alcohol Primer of Refractive Index 1.635

The primer layer 2 of refractive index 1.635 of Example 1 may be deposited as follows. A stainless-steel container is charged with 70 parts by mass of methanol, and 600 parts by mass of water. The solution is then mixed with 100 parts by mass of completely saponificated polyvinyl alcohol (Wako Pure Chemical Industries, Ltd.) having an average degree of polymerization of 1,000 mixed with 900 parts by mass of deionized water. Then, 300 parts by mass of a completely dissolved polyvinyl alcohol solution retained at 90° C. for 3 hours is mixed and dissolved in the mixture. Then, 6.0 parts by mass of a composite microparticle sol (rutile-type crystal structure; methanol dispersion; surface treatment agent, γ-glycidoxypropyltrimethoxysilane product name: Optolake, Shokubai Kasei Kogyo); solid content, 20%) of primarily titanium oxide, tin oxide, and silicon oxide is added and stirred, and 1 part by mass of urea is added and completely dissolved in the mixture. Thereafter, 7 parts by mass of a 0.1 N hydrochloric acid aqueous solution, and 1 part by mass of a silicone-based surfactant (product name: L-7604, Dow Corning Toray Co., Ltd.) are added, and the mixture is stirred for 30 minutes to give a primer layer-forming composition.

The first composition of the primer layer 2, and the Second composition of the hardcoat layer 4 are not limited to the foregoing examples. A laminate including the primer layer 2 and the hardcoat layer 4 of various compositions (systems) may be formed in the binder layer-containing laminate 12.

### 3.2 Simulation

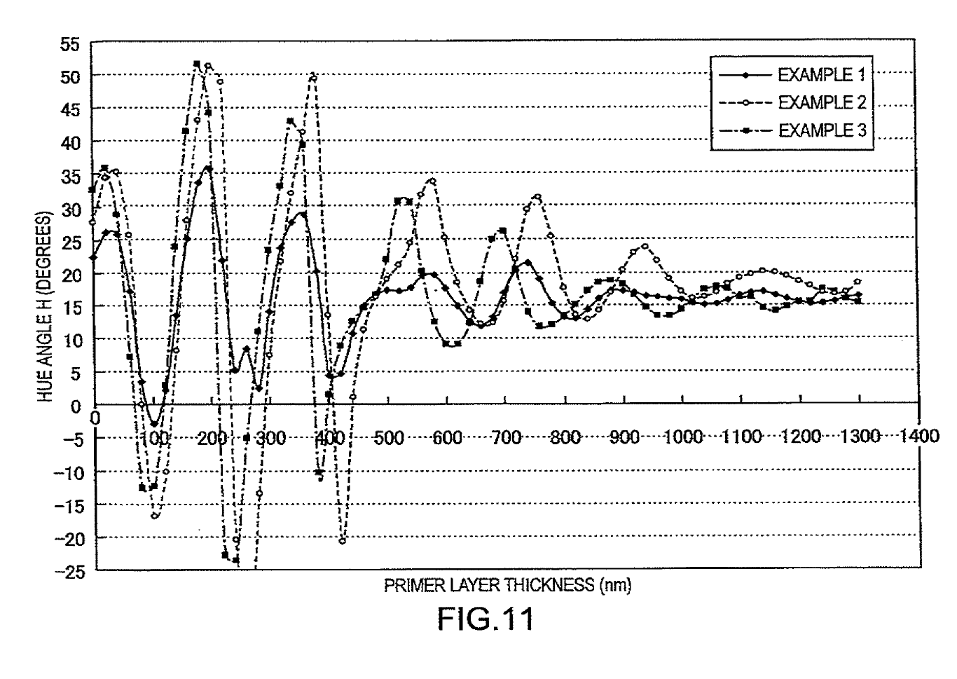

FIG. 11 is the result of a simulation between primer layer 2 thickness and hue angle H performed under the conditions of FIG. 6 for the eyeglass lens samples of Examples 2 and 3, for which the thickness of the binder layer 3 was set to 100 nm. FIG. 11 also shows the simulation result for the eyeglass lens sample of Example 1. The trend observed in the relationship between primer layer 2 thickness and hue angle H for the eyeglass lens of Example 1 was also observed in the eyeglass lenses of Examples 2 and 3.

### 4. Relationship between Thicknesses of Primer Layer and Binder Layer

The minimum thickness Tm(2.5) of the primer layer 2 that produces a hue angle displacement H2 higher than ±2.5° was also found by simulation for each sample of Examples 2 and 3. FIG. 12 shows the results as a function of the thickness of the binder layer 3, along with the result for Example 1.

The minimum thickness Tm(2.0) of the primer layer 2 that produces a hue angle displacement H2 higher than ±2.0°, and the minimum thickness Tm(1.5) of the primer layer 2 that produces a hue angle displacement H2 higher than ±1.5° were also found by simulation for each sample of Examples 1, 2, and 3. FIG. 13 shows the minimum values for Examples 1, 2, and 3 as a function of the thickness of the binder layer 3.

As presented in FIG. 7, the thickness of the binder layer 3 is preferably 35 nm or more, more preferably 50 nm or more. Further, it can be seen from the results presented in FIG. 7 and FIG. 12 that, with a primer layer 2 thickness of 700 nm or more, the hue angle displacement H2 of the optical article provided with the binder layer-containing laminate 12 can be confined in the same range obtained in the optical article provided with the binder layer-less laminate 11, specifically, a displacement H2 of about ±2.5°, making it possible to suppress the fringe pattern as effectively as in the optical article provided with the binder layer-less laminate 11. Further, with a primer layer 2 thickness of 800 nm or more, the displacement H2 can be confined to about ±2.5° even for a binder layer 3 thickness of 50 nm or more, making it possible to provide an optical article having improved adhesion and less fringe pattern.

The displacement H2 can be confined to about ±2.5° in all of the samples of Examples 1 to 3 even for a binder layer 3 thickness of 50 nm or more, provided that the thickness of the primer layer 2 is 1,000 nm or more. Optical articles with further improved adhesion and less fringe pattern can thus be provided with good yield.

Further, it can be seen from the results presented in FIG. 13 that the hue angle displacement H2 can be confined to about ±2.0° or less, and even about ±1.5° or less, even for a binder layer 3 thickness of 0.50 nm or more, provided that the thickness of the primer layer 2 is 900 nm or more, making it possible to provide an optical article with further improved adhesion and even less fringe pattern. As noted above, the thickness of the primer layer 2 is preferably 2,000 nm or less, more preferably 1,500 nm.

### 5. Review

As demonstrated above, the adhesion between the primer layer 2 and the hardcoat layer 4 can be improved by providing the binder layer 3 of lower refractive index than those of the primer layer 2 and the hardcoat layer 4, and by setting the thickness of the binder layer 3 to at least 35 nm in optical articles such as the eyeglass lens 10 that includes the primer layer 2 formed on the optical base material 1, and the hardcoat layer 4 formed on the primer layer 2 via the binder layer 3. In this way, the primer layer 2 and the hardcoat layer 4 can be combined using various compositions, making it easier to manufacture optical articles provided with the optical base material 1 of high refractive index. Further, because the fringe pattern can be suppressed by setting the thickness of the primer layer 2 to at least 700 nm, optical articles with improved optical performance can be provided.

The optical article is not limited to the eyeglass lens 10, and may be various types of thin optical lenses, including a camera lens, a telescope lens, a microscope lens, and a condensing lens for steppers, or may even be, for example, a prism, a glass, and a DVD. Products using such optical articles such as eyeglasses, also fall within the scope of the invention.

As revealed in the foregoing simulations, the further preferable thickness of the binder layer 3 is at least 50 nm. The thickness of the primer layer 2 is preferably at least 800 nm, more preferably at least 900 nm, and further preferably at least 1,000 nm.

The laminate 12 including the binder layer 3 can be fabricated using an optical article manufacturing method that includes applying and temporarily calcining the first composition used to form the primer layer 2 on the optical base material 1, and forming the laminate 12 on the optical base material 1 by applying and calcining the second composition used to form the hardcoat layer 4. Under controlled temporary calcining temperature th, the laminate 12 can be formed to include the primer layer 2 on the optical base material 1, the binder layer 3 of lower refractive index than that of the primer layer 2, and the hardcoat layer 4. Thus, an optical article including the binder layer-containing laminate 12 can be manufactured by the simple method of controlling the temporary calcining temperature th. The thickness of the primer layer 2 in the binder layer-containing laminate 12 is generally set so that it exceeds the design value for the primer layer 2 of a common optical article provided with the binder layer-less laminate 11 by a factor of about 2, preferably about 2.5 or more. In this way, optical articles with the suppressed fringe pattern and improved optical performance can be provided.

The entire disclosure of Japanese Patent Application No: 2009-261585, filed Nov. 17, 2009 is expressly incorporated by reference herein.

What is claimed is:

1. An optical article comprising:
an optical base material;
a primer layer formed on the optical base material;
a binder layer; and
a hardcoat layer formed on the primer layer via the binder layer,
the primer layer having a thickness of at least 700 nm,
the binder layer having a lower refractive index than the refractive index of the primer layer and the refractive index of the hardcoat layer, and
the binder layer having a thickness of at least 35 nm.

2. The optical article of claim 1, wherein the primer layer has a thickness of at least 800 nm.

3. The optical article of claim 1, wherein the primer layer has a thickness of at least 900 nm.

4. The optical article of claim 1, wherein the primer layer has a thickness of at least 1,000 nm.

5. The optical article of claim 1, wherein the binder layer has a thickness of at least 50 nm.

6. The optical article of claim 1, wherein the optical base material has a refractive index of at least 1.7.

7. The optical article of claim 1, further comprising an inorganic, multilayer antireflective layer formed on the hardcoat layer.

8. The optical article of claim 1, wherein the optical base material is a lens base material.

9. A method for manufacturing an optical article, the method comprising:
applying and temporarily calcining a first composition used to form a primer layer on an optical base material; and
forming a laminate on the optical base material by applying and calcining a second composition used to form a hardcoat layer,
the laminate being formed under controlled temporary calcining temperature so as to laminate: the primer layer on the optical base material; a binder layer of lower refractive index than the refractive index of the primer layer; and the hardcoat layer.

10. A method for designing an optical article provided with a binder layer-containing laminate that includes: a primer layer on an optical base material; a binder layer of lower refractive index than the refractive index of the primer layer; and a hardcoat layer,
the method comprising setting the thickness of the primer layer in the binder layer-containing laminate to a second thickness that is at least twice as thick as a first thickness of a primer layer of a binder layer-less laminate that includes the primer layer and a hardcoat layer laminated on an optical base material.
